(19) United States
(12) Patent Application Publication
(10) Pub. No.: US 2015/0310484 A1
(43) Pub. Date: Oct. 29, 2015

(54) System and Method for Tracking User Engagement with Online Advertisements

(71) Applicant: Chartbeat, Inc., New York, NY (US)

(72) Inventors: Anthony Haile, New York, NY (US); Alex Carusillo, New York, NY (US); Joshua Schwartz, Brooklyn, NY (US)

(73) Assignee: Chartbeat, Inc., New York, NY (US)

(21) Appl. No.: 14/259,857

(22) Filed: Apr. 23, 2014

(51) Int. Cl. G06Q 30/02

(52) U.S. Cl. CPC G06Q 30/0246

(57) ABSTRACT

Methods and systems for tracking a user's engagement with an object on an electronic page, such as an ad, are provided. An electronic page have an associated ad is loaded in an application, such as a browser or another native application, on a user computing device. The user computing device determines whether the user is actively engaged with the electronic page while the ad is in view on the display of the user computing device. When a reporting condition is met, the user computing device transmits data representing the result of the determinations obtained over a reporting period to an external computing device. The functionalities for tracking the user's active engagement with the ad can be provided by an ad-tracking code embedded in a webpage retrieved from a publisher's website, or by a component or module of a native application installed on the user computing device.

### BACKGROUND

Tracking online consumer behavior, such as how consumers interact with a particular website or a particular item of content on the website, such as an advertisement (“ad”), may help organizations make decisions that improve the effectiveness of their websites, such as increasing online traffic or increasing the volume of online transactions, etc.

In online advertising, specifically, an advertiser may pay a website owner (a “publisher”) to include the advertiser's ads on one or more of the publisher's webpages. A publisher may display ads from multiple advertisers on its webpages. Online ads can include text, images, Flash objects, streaming video or audio, or other objects or elements that may be used to market products or services. The publisher can include links or elements (“ad-codes”) into the hypertext markup language (HTML) of its webpages, which instruct users' browsers to retrieve ads from remote ad-servers operated by advertisers or from ad-servers operated by third-party intermediaries, such as advertising networks or brokers. When the webpage is received by a browser of a user computing device (e.g., a computer, tablet, smartphone, etc.), the ads are loaded and rendered according to the position, timing, and other instructions coded in the webpage.

Traditionally, the effectiveness of ad campaigns have been based on the number of “clicks” on their ads (i.e., the number of times a user activates the ad), or simply based on impressions of the ads (i.e., the number of times an ad is in the user's view, whether it is clicked on or not). These clicks or impressions can also be used as a basis for compensation to the publishers.

The existing advertisement monitoring approach and compensation model has various drawbacks. For example, the total number of download requests for an ad may include fraudulent activity. Additionally, impressions may be overcounted since it is possible that an ad has loaded but a user may not actually see the ad on the visible portion of their device screen.

Thus, there is a need for improved techniques and metrics for tracking online ads to allow for better measurements of the performance of advertising campaigns.

### SUMMARY

The purpose and advantages of the disclosed embodiments will be apparent from the description that follows, and through the practice of the disclosed subject matter. The systems and methods disclosed herein can apply to tracking of an image, video, block of text, audio file, Flash® object, or any other element or content on a webpage or electronic page. Furthermore, it should be understood that although embodiments are described in the context of online ads, the embodiments are applicable to other types of content.

In accordance with certain embodiments, a method of tracking a user's exposure to an ad associated with an electronic page of an application installed on a user computing device is provided. As used herein, a user computing device can be a desktop computer, a laptop computer, a mobile device such as a smart phone (e.g., one based on Android, iOS, Windows Mobile, etc.), a PDA, a tablet (e.g., Nexus 7/10, iPad, etc.), and the like. The application can be a generic web browser, such as Microsoft Internet Explorer®, Mozilla® Firefox, Chrome®, Safari®, etc. (including their desktop versions as well as mobile versions for mobile operating systems such as iOS® and Android®). The application may also be a mobile application or such as a game, an email reader, a word processor program, a newsreader program, etc., that can display ads and perform the ad tracking methods described herein.

In some embodiments, the electronic page is a webpage retrieved by a browser or another application from an external web server. In other embodiments, the electronic page includes a displayable portion of a user interface of a native application (e.g., an app installed on a smartphone). The ad can occupy a designated area within the electronic page, e.g., contained within a webpage, contained in a separate layer or window superimposed the application view or window.

In accordance with the method, the user computing device determines, at one or more times, whether the user is actively engaged with the electronic page while the ad is in view based on a first predetermined schedule (e.g., a first time interval, such as per second). Such user's active engagement data may be aggregated over one or more reporting periods, each of which encompasses the one or more determinations of the user's engagement. Any number of actions may be deemed active engagement with the electronic page or webpage, including direct interaction with the page (e.g., scrolling the page, mouse clicks on the page, key-strokes on the page) or indirect interaction with the page while it is active (e.g., movement of the mouse or other interface device, movement of a gyroscope on a user's mobile device, etc.). The reporting period may be a second time interval that is equal to or greater than the first time interval to obtain a measurement of user's exposure to the ad during that period. Such a measurement may be quantified or expressed numerically, e.g., in time units, or in a sense, a score. Then, the user's engagement data over the reporting period may be transmitted to an external computing device, such as a remote server linked with the user computing device, for storage, analysis, and/or being made available to the advertiser.

The process of determining, aggregating, and transmitting a user's active engagement data can be repeatedly performed while the electronic page is loaded on a user's computing device and for multiple users for a duration of time desired by the ad provider, e.g., a time period for the advertising campaign. During such a period, the active engagement data for one or more online ads, by the same or different users can be pooled together (aggregated) for analysis. The analyzed data can be presented via a user interface to an interested party, such as the provider of the ad. The interface can be hosted by a platform operator or service provider, and can include input elements to allow the interested party to specify one or more criteria or filters to view the analyzed data for one or more ads provided by the interested party.

According to certain embodiments, program code (e.g., a script written in JavaScript) or a reference to a computer file containing program code for tracking a user's active engagement, can be included in a webpage of a content provider or publisher. The webpage may also include the source of or a reference to one or more ads. The webpage is electronically sent via a data connection, e.g., through the Internet and/or other network, to a user computing device. Once being retrieved by the user computing device, the webpage can be opened by a web browser installed on the user computing device that is capable of interpreting and displaying the webpage, as well as executing the program code.

In some embodiments, after the browser of the user computing device loads the webpage on the user computing device, the program code contained or referenced in the webpage is executed by the browser, to cause a processor of the user computing device to:

(a) Determine, at one or more times, whether both (i) the online ad is viewable at the time of the determination (which may be understood to mean that a certain portion, e.g., at least 50%, of the ad is in the viewable portion of the then current active screen of the browser), and (ii) the user has interacted with the webpage within a certain time window preceding the determination. The determinations can be started upon loading of the webpage, or upon loading or retrieval of any particular ad being monitored. The determination may be made, for example, in accordance with a first time schedule, such as every second. The time interval or window for evaluating whether the user has interacted with the webpage may vary or may be fixed, such as certain number of seconds (X) prior to the processor making the determination. The window may or may not cover the time of the determination. In certain embodiments, the time interval is 3-15 seconds, or preferably, 4-8 seconds, or preferably about 5 seconds. Thus, by way of example, every second the processor may determine whether (1) the ad is viewable and (2) the user has interacted with the webpage in the immediately preceding five seconds. The processor may produce an indication or score when both conditions are met for each determination (and can optionally also produce a different indication or score when both conditions are not met). Further, the processor may increment a counter or otherwise track each instance for which both of the conditions are met.

(b) When a reporting condition is met, transmit data representing the user's engagement with the ad for the current reporting period, i.e., the period subsequent to the previous reporting, or subsequent to the initial loading of the webpage or loading of the ad if no previous reporting was done, together with identifying information of the ad (and optionally the length of the current reporting period and other information regarding the ad), to an external computing device, such as a server which provides the program code, or another server, for storage, analysis, and/or retrieved by the advertiser or publisher. A reporting condition can be based on a recurring time schedule, e.g., when a predetermined number of determinations have been performed, or when a predetermined reporting time period has elapsed, e.g., Y seconds, where Y can be a variable which can be greater than X, for example, Y can be 10-300 seconds, or preferably about 15 seconds. The length of a reporting period can be preselected based on the frequencies of the active engagement determinations, and/or adjusted dynamically based on user's browsing behavior (e.g., the reporting can be done less frequently when the user is idle on the webpage and more frequently when the user is active). Additionally or alternatively, the reporting condition can also include events occurring on the webpage, including: when the webpage has been closed by the user, when the webpage crashes, when the webpage has been determined to be inactive (e.g., because the user has navigated away from the webpage to another webpage, or there has been no user activity for a predetermined time period). Further, if desired, reporting can be performed when the webpage is first loaded, or whenever it is determined that the ad is viewable and the user is actively engaged with the webpage.

Although in the foregoing embodiment the viewability determination takes into consider whether the browser is the active window on the user device, in alternate embodiments, the determination of whether the browser is the active window may be part of the user interaction determination or a separate determination.

The program code configured to carry out the herein described functions of tracking the user's active engagement (herein referred to as ad-tracking code) can be directly embedded in the webpage on the hosting server, or referenced by a URL in the webpage code and physically stored on a remote device (e.g., a server run by an ad-tracking service provider). The ad-tracking code can be written in JavaScript or any other language understood by the browser of the user computing device. Likewise, the ad can be directly embedded in the webpage on the hosting server or retrieved from an external server, such as an ad server.

In accordance with other embodiments, a non-browser native application installed on the user mobile device can display an electronic page including an ad, and track the user's active engagement with the ad. In such situations, the native application can use an ad-generating component or module to obtain ads from a local storage of the user computing device, or retrieve ads from one or more external ad servers. Further, instead of using program code retrieved from a web server to track the user's engagement with the ads, the native application itself can be developed using a software development kit (SDK) configured to enable the native application to track the user's engagement with the ads based on the visibility of the ad and user interactions with the electronic page according to the methods described herein. Thus, it should be understood that embodiments described as pertaining to a webpage displayed within a web browser are equally applicable to native applications.

In alternative embodiments, a method is provided, which comprises: displaying an electronic page by an application installed on a user computing device, the application including an ad-generating component and an ad-tracking component; using the ad-generating component of the application to cause a processor of the computing device to obtain at least one ad from a local storage of the user computing device or from an external ad server; and using the ad-tracking component to cause the processor of the computing device to perform the following: (1) determining, at one or more times of determinations, whether both of the following conditions are met: (i) the at least one ad is in view on a display of the user computing device, and (ii) the user is actively engaged with the electronic page; (2) when a reporting condition is met, transmitting data representing the result of the one or more determinations obtained over a reporting period (which encompasses the one or more times of determinations) to an external computing device. As with other embodiments described herein, determining whether the user is actively engaged with the electronic page can be based on a detection of at least one user interaction with the electronic page during a predetermined time window immediately preceding the time of the determination. In some of the embodiments, the ad-tracking component of the application can be developed using a software development kit (SDK) configured to enable the application to cause the processor of the user computing device to perform steps (1)-(2) noted above. The SDK can be provided by an ad tracking code provider to the developer of the application. The user computing device can be a mobile device, and the application can be a mobile app.

### BRIEF DESCRIPTION OF THE DRAWINGS

FIG. 1 schematically depicts the process of a browser of a user computing device loading various components of a webpage of a publisher's website, according to some embodiments of the present invention.

FIG. 2 schematically depicts the process of determining active engagement with an ad by a user, according to some embodiments of the present invention.

### DETAILED DESCRIPTION

While the disclosed subject matter may be embodied in many different forms, reference will now be made in detail to specific illustrative embodiments, examples of which are illustrated in the accompanying drawings. This description is an exemplification of the principles of the disclosed subject matter and is not intended to limit the subject matter to the particular embodiments illustrated.

According to some embodiments, a method for tracking and, more specifically, measuring user engagement with online ads is provided. The method can provide advertisers and web publishers with a quantitative measurement of the performance or potential effectiveness of an ad placed on the web publishers' website by tracking or measuring the amount of time a user is actively engaged with the webpage containing the ad while the ad is in view of the consumers. Further, as the measurement can be quantified, e.g., in time units, it allows the web publisher and the advertiser to negotiate their agreements for ad-placement and promotion services based on “quality time” the users engage with the webpage (or application) with the ad in view, instead of based on the duration of time the ad is run on the publisher's websites.

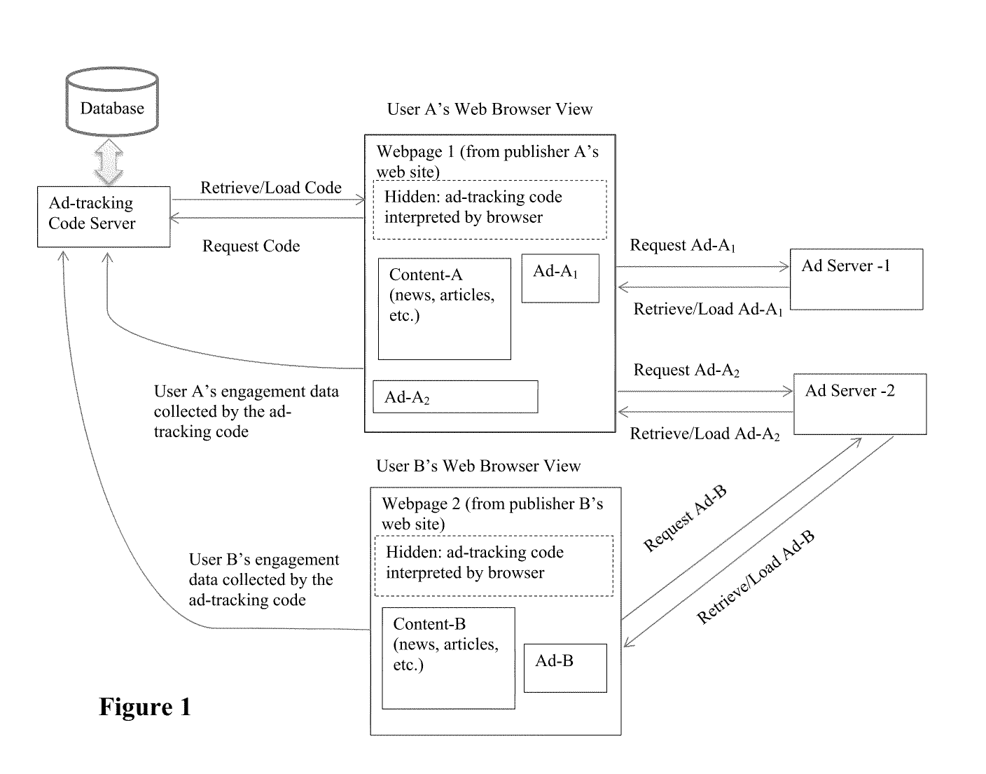

The method can be implemented in a distributed computing environment as illustrated in FIG. 1. In FIG. 1, the web server computers (e.g., run by the publishers) can host webpages in an HTML or other modern mark-up language suitable for web design (e.g., XHTML or XML, with suitable style sheets). Webpages can be transferred between web servers and clients using unsecured or secured communication protocols such as HTTP, HTTPS, etc. A given webpage (host page) can include various items of content. For example, the webpage can include text, images, videos, audio, etc., or references or links to external resources (e.g., URLs, which specifies the location of remote web servers at which other files may be located). When a webpage is retrieved by a browser of the user computing device, the content contained in the webpage can be loaded and displayed to the user within the browser. The webpage can also include program code directly or indirectly (e.g., by referencing an external file containing program code). When the program code is downloaded to the browser, the code can be translated by the browser into instructions that can control, monitor, modify, and/or otherwise affect the display and behavior of various items of content of the webpage as well as monitor and/or respond to various events occurring on the webpage, e.g., the user's interactions with the webpage. The program code can be written in a text-based script language, e.g., JavaScript, or a full programming language, e.g., Java (which must be first compiled before being downloaded to the browser), or any other programming language that can be interpreted by the browser into instructions capable of manipulating contents and responding to events occurring on the webpage. The program code is typically hidden from the user's view.

As illustrated in FIG. 1, the embodiment encompasses any number of publishers (P), webpages, web servers, ad servers, users, and user computing devices. For example, webpage 1 (from publisher A) is loaded on user A's web browser and includes a reference to an ad-tracking program code, Content-A (which can include news, articles, email messages, etc.), and references to two online ads Ad-A₁ and Ad-A₂. The ads can be placed in different sections of the webpage (e.g., different DIVs, frames, or zones). While it is shown in FIG. 1 that the Content-A, Ad-A₁ and Ad-A₂ are all visible at once, depending on the actual information in these content items, the size of these content items, and the screen size and/or settings of the user's browser, they may not all be visible at the same time. Upon loading of the webpage 1 by user A's web browser, user A's web browser requests the ad-tracking code from an ad-tracking code server, and retrieves the code from the ad-tracking code server. User A's web browser further requests and retrieves Ad-A₁ from Ad Server-1, and requests and retrieves Ad-A₂ from Ad Server-2. The same ad-tracking code can be included in another webpage of publisher A's website, or a webpage of another publisher, publisher B's website (e.g., webpage 2, as shown in FIG. 1). The same user A, or another user B, can access and download webpage 2, which also includes Content-B, and a reference to an online ad Ad-B. User B's web browser can also request the ad-tracking code from the ad-tracking code server, and retrieve the code from the ad-tracking code server. Similarly, as shown in FIG. 1, user B's web browser requests and retrieves Ad-B from Ad Server-2 (if Ad-B is hosted on another ad server, user B's web browser can request and retrieve Ad-B from such ad server).

Once the ad-tracking code is loaded by the user's web browser, it enables the browser to actively monitor the positions and visible areas of each of the ads in the user browser screen, and make determinations whether the user is actively engaged with the webpage while any target ad is in the user's view. The ad-tracking code further aggregates such active engagement data and transmits the data at appropriate times to an external computing device, e.g., a server for data storage and/or further analysis. Although it is depicted in FIG. 1 that such external computing device for data storing/analysis is the same server as the server which hosts the ad-tracking code, the external computing device can also be a different server, e.g., another server operated by ad-tracking code provider, a server operated by the publisher, a server operated by an ad provider, or a server operated by another properly authenticated third party who is interested in monitoring and/or analyzing the aggregated user engagement data.

As used herein, online ads can include electronic representation of text, images, multimedia (e.g., streaming video and/or audio), or other information that are intended to promote products or services of an advertiser. To display an ad to a user on a web browser of the user computing device, the ad can be included in the host page on the web server as a static link to a desired ad retrievable from an ad server, or it can be included as a dynamic link, e.g., a link that is selected by a client-side or server-side script from multiple ad sources and/or tailor made for a particular user based on the user's preference or browsing behavior, etc. An online ad can be placed in-line with other items of content of the webpage, or a designated area of the webpage (e.g., in a DIV element of the webpage) which can become out of view when the user scrolls to a different portion of the webpage. However, it is understood that the ad can also be designed to occupy a fixed section or layer of the webpage, which can allow the ad to be visible to the user as long as the webpage is active, or make the ad appear and disappear based on a user interaction with the webpage in certain way, e.g., scrolling to the bottom of the webpage. Alternatively, the ad can be loaded in a separate webpage that is triggered or spawned by a user's interaction with an underlying webpage, e.g., a mouse hover event or a scroll event. In other situations, a collection of online elements or a portion of a webpage can be considered an online ad. Such an ad may be sponsored or paid for by an advertiser, and its content may or may not explicitly identify the branding of the advertiser.

According to some embodiments, the ad-tracking code, e.g., a JavaScript program, once loaded in the webpage by the user browser, can perform functions that track the user's active engagement with the webpage while a target ad (e.g., Ad-A₁) is in view, as will be further described below.

For the ad-tracking code to work properly with the ads included in a publisher's webpage, certain preliminary configuration of the webpage can be made such that the ad-tracking code can correctly identify the ads on the webpage to be tracked. For example, each ad can be identified by a unique ID of HTML elements or attributes at a document level of the webpage, e.g., by a HTML5 document attribute data-cb-ad-id. The parameters of each of the ads can also be made available to the ad-tracking code, e.g., a name, position, width, height, image source, etc. Each of the ads can be individually tracked (and have their individual clock counters) from the time each ad is loaded in the webpage by the browser. The webpage can also include in a head section (or another section) a JavaScript code to specify the source location for the ad-tracking JavaScript, as well as initialize different variables with appropriate values as required for running the ad-tracking JavaScript.

Once the ad-tracking JavaScript code is loaded and activated on the webpage in the user's web browser, it preferably enables the browser to track the user's interactions in real-time with the webpage as a whole, e.g., a scroll movement (e.g., by keyboard or finger on a touchscreen), a mouse movement, a mouse click, a keypress, etc. The browser, as instructed by the ad-tracking code, also makes determinations on a predetermined schedule whether the user is actively engaged with any ad while such ad is in the user's view. The ad-tracking code can save or log such interactions data in a local memory of the user computing device, and transmits selected logged data at appropriate times to an external server.

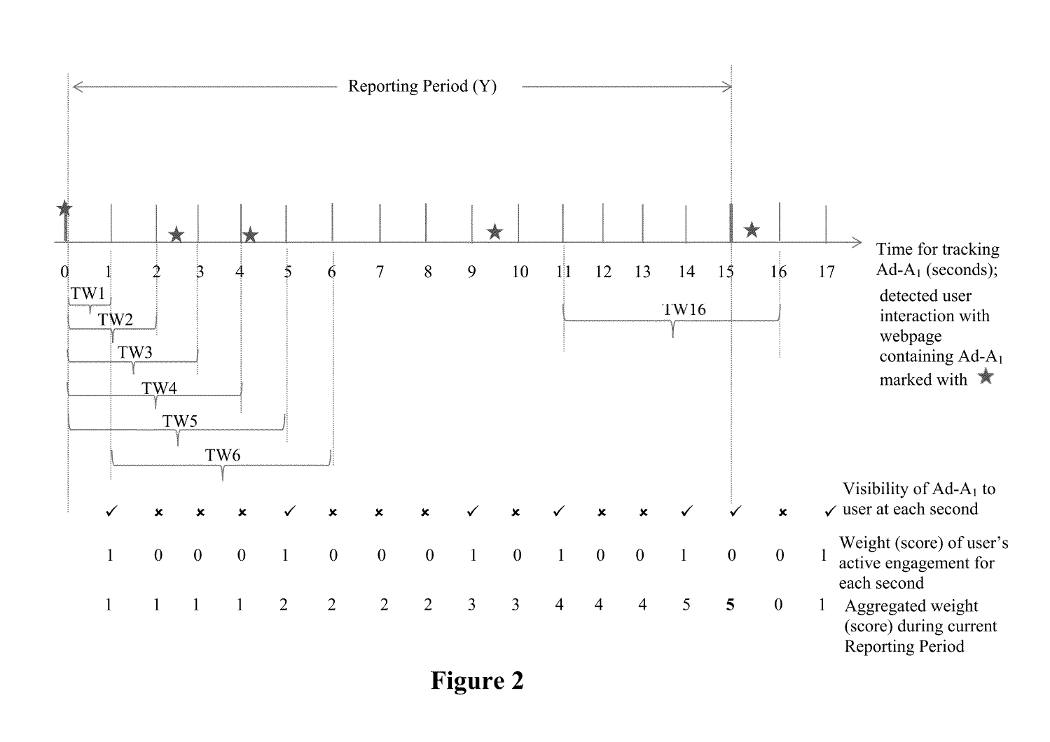

For purpose of illustration and not limitation, FIG. 2 schematically depicts how the ad-tracking code measures the user A's engagement with the webpage containing Ad-A₁. Time 0 is when the webpage containing Ad-A₁ is first loaded in the user web browser (alternatively, it can be understood as the time the ad Ad-A₁ is first loaded within the webpage, as there may be lapse of time from the loading the webpage to the loading of the ad). Based on a predetermined time schedule specified in the ad-tracking code, the browser repeatedly determines whether the user is actively engaged with the webpage while the ad is in the user's view. As shown in FIG. 2, the determination can be performed on a per second basis.

At each determination (i.e., every second as shown in FIG. 2), the browser determines whether Ad-A₁ is in the user's view at the time of the determination. In some embodiments, such requirement is met when at least fifty percent (>=50%) of the area occupied by the online ad is visible to the user. If the ad is an audio or video, the visibility requirement may also require that the audio/video content is actively playing. Also, in order for an ad to be considered to be in the user's view, the webpage containing the ad must be, at the time of the determination, an active page (or tab) viewable by the user, and the web browser needs to be a currently active program on the display of the user computing device. The ad-tracking code can include functions to determine the visibility of any target ad, e.g., based on the current position of the ad (e.g., by obtaining the left offset and top offset of the ad), the width and height of the ad, current scroll position, page zoom level, etc. For illustration, in FIG. 2, when it is determined that Ad-A₁ is in the user's view at a time of determination, i.e., all of the above visibility requirements are met, that time of determination is denoted by “V”; otherwise that time of determination is denoted “x”.

Further, at each determination, according to the instructions of the ad-tracking code, the browser also determines whether the user is actively engaged with the webpage containing Ad-A₁. This can be done by checking the real-time monitoring data collected during an applicable time window immediately preceding the time of the determination to determine whether, at any time during that time window, the user has interacted with the webpage during the past X seconds, X being 5 in the example illustrated in FIG. 2. The user interaction with the webpage refers to any user interaction with an input of the user computing device such as keyboard, mouse, touchscreen, an embedded accelerometer/gyroscope/GPS receiver while the webpage is active or such interaction causes the webpage to become active, e.g., that the user presses on a key of the keyboard, scrolls or clicks a mouse, touches or swipes a touchpad, presses on a touch screen. When the user computing is a mobile device, tilting or otherwise moving the device can also constitute user action with the webpage.

Using the 5-second window as an example, and as illustrated in FIG. 2, at the time of determinations marked by 1st, 2nd, 3rd, 4th, 5th, 6th, and 16th second, the time windows used to determine the user's interaction with the webpage are denoted by TW1, TW2, TW3, TW4, TW5, TW6, and TW16, respectively. Each of TW1, TW2, TW3, and TW4 is truncated at time zero because there is no data available before time zero (when the webpage is first loaded in the browser, or when the ad is first loaded in the webpage). As shown in FIG. 2, a user interaction with the webpage is detected between 2nd and 3rd second, between 4th and 5th second, between 9th and 10th second, and between 15th and 16th second. At time zero, the action by the user to load the webpage can also be considered a user interaction with the webpage (if it is determined that the webpage was loaded by another mechanism without user's input or action, the loading of the webpage can be considered not a user interaction with the webpage).

For each of the determinations, if it has been determined that the user is actively engaged with the webpage while the target ad is in the user's view, that is, all requirements of visibility are satisfied at the time of the determination and it is determined that the user has interacted with the webpage during the applicable time window preceding the time of determination, then that time of determination is assigned to a predetermined weight or score. Although the weight or score can be any number, it can be advantageous to use a number that correlates with the frequencies of the determination. For example, the weight or score can be “1” if the determination is made on a per second basis (which can be intuitively understood as that second is counted as a second that the user is actively engaged with the ad). Optionally, upon each determination, the ad-tracking code can enable the browser to increment a variable indicating an aggregated weight or score by the predetermined weight assigned to the time of the determination. For illustration, based on the visibility of Ad-A₁ and the user interaction history in the respective applicable time windows shown in FIG. 2, the individual weights and the aggregated weights at each determination (i.e., from each determination from the 1st to the 17th second, on a per second basis) are computed and shown in FIG. 2.

The determinations of the user's active engagement can be repeated until a preset reporting condition is met. The reporting condition can be when a predetermined number of determinations have been performed or when a predetermined reporting time period has elapsed. As depicted in FIG. 2, the reporting condition is set as per 15 seconds (for illustration, only the first 15 seconds are shown in full). Other reporting conditions can be set that are not based on regular time intervals, but based on browser events or user activity (or inactivity), e.g., when the webpage has been closed by the user, when the webpage crashes, when the webpage has been determined to be inactive (because the user has navigated away from the webpage, or there has been no user activity for a predetermined time period), etc. Further, if desired, a reporting can also be performed when the webpage is first loaded, or whenever it is determined that the ad is viewable and the user is actively engaged with the webpage.

When any of the above conditions occurs, a reporting process can be performed by the browser. For example, the ad-tracking code can enable the browser to compute an aggregated weight or score for the current reporting period (or it can be updated at each individual determination), e.g., a sum of the active engagement determinations during the current reporting period, and to transmit the aggregated weight or score, with identifying information of the ad (and optionally the length of the current reporting period, as well as other information of the ad, e.g., webpage URL, size and positioning information, as necessary or desired, as reflected in the below illustrative string), to an external server for storage and/or analysis. For example, if a reporting condition is set such that the reporting process is to be performed for every 15 seconds, as illustrated in FIG. 2, the browser will send, on intervals of every 15 seconds (as long as the webpage is not closed), the aggregated weight of the current reporting period, with identifying information of the ad (e.g., unique identifier, “adID”) and other information, to the external computing device. As shown in FIG. 2, the aggregated weight (e.g., “engaged_time”) for the reporting period 0-15 seconds is 5 for Ad-A₁, which can be intuitively understood as 5 seconds of active engagement with the ad by the user during the 15-second long reporting period. At the time of reporting at the 15th second, the browser can send this value together with identifying information for Ad-A₁, to the external computing device or server. As an example, the data about each ad can be formatted into a string of the form: adID=engaged_time::ad_width::ad_height::ad_left_offset::ad_right_offset, and an “&” separated list of other ad data can be URL-encoded and put into the “ad” field of the URL of the ad-tracking code for transmitting to the server as a HTTP request.

The ad-tracking code may also be configured to enable the user browser to perform a reporting process for other conditions based on browser events or user interactions. For example, if the reporting condition is met because of the webpage is closed, deemed to be inactive, or otherwise terminated, the browser can transmit the logged user engagement data (including the individual and/or aggregated weight assigned to each determination after the previous reporting) collected during the current reporting period. This can be accomplished by an appropriate event handler implemented in the ad-tracking code (e.g., an onunload function in JavaScript). For example, referring to the scheme illustrated in FIG. 2, if the browser is terminated between 17th and 18th second, a second reporting (after the first reporting performed at the 15th second) can be made to transmit the user engagement data captured at the 16th and 17th determinations to the external computing device for storage or analysis.

After the transmission of the user engagement data, if the webpage is not closed, the ad-tracking code will continue to perform the above-described functions to track the user's active engagement. If an aggregated weight variable is computed during a reporting period, that variable can be reset to zero for the next reporting period (as shown in FIG. 2).

For a website with registered or paid users or that provides subscriber-only content, appropriate variables can be initialized in the webpage such that the ad-tracking code can track active engagement for different types of users visiting the website (e.g., based on user demographics), which allow an analysis of how much time different types of users spend engaging with the web content while the ads are in view.

The above description in connection with FIGS. 1-2 illustrates tracking a user's active engagement with an ad on a webpage using an ad-tracking code embedded in a webpage retrieved from a web server. Alternatively, a native application, such as a mobile app on a user mobile device, can display an electronic page including an ad, and track the user's active engagement with the ad based on the methods described above (“electronic page” is considered a “webpage” in this context). In such situations, the native application can use an ad-generating component or module to obtain ads from a local storage of the user computing device, or retrieve ads from an external ad server(s). The process for retrieving ads from an external server can be essentially the same as for a webpage. The ads can be displayed in a separate area in the electronic page that is designated for ad display. The native application further includes an ad-tracking component or module to track the user's engagement with the ads based on the visibility of the ads and user interactions with the electronic page according to the methods described herein. The functionalities of the ad-tracking component in the native application can be similar to those of the interpreted ad-tracking code in a web browser as illustrated above, and the various aspects and parameters of the methods illustrated in connection with FIGS. 1 and 2 for tracking an ad included in a webpage and retrieved by a web browser are also applicable for the ad-tracking component of the native application. The ad-tracking component can be developed using an SDK configured to enable the native application to perform the above ad tracking functionalities. The SDK can be provided by an ad-tracking code provider.

The user engagement data for each ad transmitted to the external server can be further aggregated and sent according to a predetermined schedule, e.g., per minute or per 10 minutes, to another server which is suitable for large scale data warehousing (e.g., a cloud server such as Amazon S3 cloud storage server). When an advertiser is running an ad campaign, (s)he may run a set of ads across many different publishers' websites (and/or different ads on different publishers' websites as well). In such a scenario, the identifying information for the same ad across different publishers' websites can be set as the same and recognized by the ad-tracking code as such, so as to properly group the active engagement data for the ads across different webpages, websites, or domain names. The user engagement data of the ads from websites of different publishers can be further converted and incorporated into a database coupled with the external server (as illustrated in FIG. 1), such as a MySQL database.

The aggregated and/or warehoused user engagement data can be processed in any way (e.g., using native query language provided by the database management system and/or any other suitable programming language which can access and manipulate the data in the database) to obtain information in a format that may be useful for an interested party, e.g., average active engagement or exposure time by all users (or any types of users) for any specific ad or any selected group of ads. In some embodiments, a web server, e.g., a server of operated by the provider of the ad-tracking code, can be programmed (e.g., using server-side script language, such as PHP, Python, etc.) to access and analyze a large amount of stored user engagement data aggregated over an extended period of time, e.g., days or weeks, and to present the user engagement data on a user interface in a manner previously agreed upon by the interested party or specified by the interested party on the user interface on-the-fly. For example, the web server can present a “dashboard” web interface which is accessible by an authorized interested party over the internet using a login credential and a secured web address. The dashboard interface can include tools (e.g., web forms including selectable or editable responsive elements) to allow an interested party to select one or more criteria to view the performance or effects of the ads of interest.

The analyzed user engagement data regarding an ad can be sent back to the user computing device. The ad-tracking code included in the webpage (or the ad-tracking component of the native application) can be configured to enable the web browser (or the native application) of the user computing device to receive such analyzed data regarding the ad being monitored or tracked, and perform an action in response thereto. For example, the web browser or the native application can switch the ad with a new ad after a total amount of user engagement has been reached for the ad.

While illustrative embodiments of the invention have been disclosed herein, numerous modifications and other embodiments may be devised by those skilled in the art in accordance with the invention. For example, the various features described in the embodiments herein can be altered or combined accordance with the invention. Therefore, it will be understood that such modifications are within the spirit and scope of the present invention.

1. A method for use with an electronic page loaded on a user computing device having a display, wherein the electronic page has an associated ad, the method comprising:
(a) the user computing device repeatedly determining, while the electronic page is loaded on the user computing device, for each of multiple determination periods, whether both of the following conditions are met:
(i) the ad is in view on the display of the user computing device, and
(ii) the user is actively engaged with the electronic page,
wherein determining whether the user is actively engaged with the electronic page is based on a detection of at least one user interaction with the electronic page during a predetermined time window immediately preceding the determination period; and
(b) for each of one or more reporting periods, wherein each reporting period includes multiple determination periods, transmitting to an external computing device data representing a result of the determinations of the determination periods occurring during the reporting period.

2. (canceled)

3. The method of claim 1, wherein the at least one ad is retrieved from a remote server.

4. The method of claim 1, wherein the electronic page is a viewable user interface of a native application installed on the user computing device.

5. The method of claim 1, wherein the electronic page is a webpage loaded in a browser installed on the user computing device.

6. The method of claim 1, wherein the determinations in (a) are made repeatedly according to a predetermined time schedule.

7. The method of claim 6, wherein the determinations in (a) are made on a per second basis.

8. The method of claim 1, wherein the predetermined time window is approximately 5 seconds.

9. The method of claim 6, wherein the time window is determined based on the predetermined time schedule for the determinations in (a).

10. The method of claim 1, wherein the time window is determined based on the user's browsing history of the electronic page.

11. The method of claim 1, wherein
of the determinations in (a) for each determination period includes assigning a non-zero score if both conditions (i) and (ii) are met in the determination period, and a zero score if either conditions (i) or (ii) is not met in the determination period; and
the data representing the result of the determinations includes an aggregate score which is a summation of the scores for the determinations in (a) in the reporting period.

12. The method of claim 1, wherein the reporting period occurs when a predetermined number of determinations in (a) have been made.

13. The method of claim 1, wherein the reporting period repeatedly occurs while the electronic page is loaded and ranges from 10 to 300 seconds.

14. The method of claim 1, wherein the reporting period ends when one or more predetermined events occur on the electronic page.

15. The method of claim 1, wherein the reporting period terminates when the electronic page is terminated.

16. The method of claim 1, wherein the user computing device is a mobile device.

17. The method of claim 1, further comprising:
analyzing, by the external computing device, the reported data representing the result of the determinations in (a); and
transmitting the analyzed data representing the result of the determinations in (a) to the user computing device.

18. A method, comprising:
in response to a request from a web browser installed on a user computing device,
electronically sending a webpage of a web server to the user computing device;
wherein the webpage includes an ad, and program code or a reference to a computer file containing program code,
wherein the program code is configured such that, upon the web browser loading the webpage on the user computing device, the program code causes a processor of the user computing device to:
(1) repeatedly determine, while the electronic page is loaded on the user computing device, at each of multiple times of determinations, whether both of the following conditions are met:
(i) the ad is in view on a display of the user computing device, and
(ii) the user is actively engaged with the webpage;
wherein determining whether the user is actively engaged with the electronic page is based on a detection of at least one user interaction with the electronic page during a predetermined time window immediately preceding the time of the determination; and
(2) when a reporting condition is met, transmit to an external computing device, data representing a result of determinations in (1) obtained over a reporting period, the reporting period encompassing a plurality of the determinations of (1).

19. The method of claim 18, wherein the program code is written in a text-based script language.

20. The method of claim 18, wherein the computer file containing program code resides externally to the web server.

21. The method of claim 18, wherein the determinations in (1) are made on a per second basis.

22. The method of claim 21, wherein the predetermined time window is approximately 5 seconds.

23. A method, comprising:
(a) by a user computing device, computing data to quantify a user's active engagement, in terms of amount of time, with at least one ad in an electronic page of an application installed on the user computing device, the at least one ad being natively generated or externally retrieved by the application; and
(b) transmitting the computed data from the user computing device to another computing device.
wherein step (a) comprises:
(i) repeatedly determining, at predetermined time intervals, whether the user is actively engaged with the electronic page while the at least one ad is in view on a display of the user computing device, wherein determining whether the user is actively engaged with the electronic page is based on a detection of at least one user interaction with the electronic page during a predetermined time window immediately preceding the time of the determination; and
(ii) for each determination in (i), if the determination result is positive, assigning a score representing the length of the time interval prior to that determination and an earlier determination, and if the determination result is negative, assigning zero to that determination; and
(iii) summing the score for each of the determinations to obtain an amount of time indicating the user's active engagement with the ad for a time period before the transmission that covers a plurality of determinations.

24. The method of claim 23, wherein the application is a browser, and wherein the at least one ad is retrieved by the browser from an external server.

25. The method of claim 23, wherein the application is a native application installed on a mobile device, and wherein the at least one ad is a native ad or retrieved by the native application from an external server.

26. A method comprising:
providing program code to an owner or operator of a web server and causing the website owner or operator to include the program code or a reference thereto in a webpage of the website, wherein the webpage also includes one or more ads,
wherein the program code is configured such that, upon a web browser of a user computing device retrieving and loading the webpage on the user computing device, the program code is translated to computer executable instructions, which when executed, cause a processor of the user computing device to
(1) repeatedly determine, while the electronic page is loaded on the user computing device, for each of multiple determinations, for at least one of the one or more ads, whether both of the following conditions are met:
(i) the ad is in view on a display of the user computing device, and
(ii) the user is actively engaged with the webpage;
wherein determining whether the user is actively engaged with the electronic page is based on a detection of at least one user interaction with the electronic page during a predetermined time window immediately preceding the time of the determination; and
(2) when a reporting condition is met, transmit data representing the result of the determinations in (1) obtained over a reporting period, the reporting period encompassing a plurality of determinations, to an external computing device.

27. The method of claim 1, wherein the ad is deemed in view if at least 50% of the ad is in view on the display of the user computing device.

28. The method of claim 18, wherein the ad is deemed in view if at least 50% of the ad is in view on the display of the user computing device.

29. The method of claim 23, wherein the ad is deemed in view if at least 50% of the ad is in view on the display of the user computing device.

30. The method of claim 26, wherein the ad is deemed in view if at least 50% of the ad is in view on the display of the user computing device.

31. The method of claim 1, wherein at least two of the predetermined time windows have different widths.

32. The method of claim 1, wherein the predetermined time window is greater than a duration between consecutive determination periods.

33. The method of claim 18, wherein at least two of the predetermined time windows have different widths.

34. The method of claim 18, wherein the predetermined time window is greater than a duration between consecutive determinations.

35. The method of claim 23, wherein at least two of the predetermined time windows have different widths.

36. The method of claim 23, wherein the predetermined time window is greater than one of the predetermined time intervals.

37. The method of claim 26, wherein at least two of the predetermined time windows have different widths.

38. The method of claim 26, wherein the predetermined time window is greater than a duration between consecutive determinations.

39. The method of claim 1, wherein the determining that the user is actively engaged with the electronic page comprises one or more of: detecting scrolling of the electronic page, detecting a mouse click on the electronic page, detecting a key-stroke on the electronic page, detecting a mouse movement or hover on the electronic page, and detecting movement of a gyroscope on the user computing device.

40. The method of claim 18, wherein the determining that the user is actively engaged with the webpage comprises one or more of: detecting scrolling of the webpage, detecting a mouse click on the webpage, detecting a key-stroke on the webpage, detecting a mouse movement or hover on the webpage, and detecting movement of a gyroscope on the user computing device.

41. The method of claim 23, wherein the determining that the user is actively engaged with the electronic page comprises one or more of: detecting scrolling of the electronic page, detecting a mouse click on the electronic page, detecting a key-stroke on the electronic page, detecting a mouse movement or hover on the electronic page, and detecting movement of a gyroscope on the user computing device.

42. The method of claim 26, wherein the determining that the user is actively engaged with the webpage comprises one or more of: detecting scrolling of the webpage, detecting a mouse click on the webpage, detecting a key-stroke on the webpage, detecting a mouse movement or hover on the webpage, and detecting movement of a gyroscope on the user computing device.

43. The method of claim 1, wherein the determination period is less than the time window, the time window is 3-15 seconds and the reporting period is 10-300 seconds.

44. The method of claim 18, wherein a length of time between immediately successive determinations is less than the time window, the time window is 3-15 seconds and the reporting period is 10-300 seconds.

45. The method of claim 23, wherein a length of the time intervals is less than the time window, the time window is 3-15 seconds and the time period before the transmission is 10-300 seconds.

46. The method of claim 26, wherein a length of time between successive determinations is less than the time window, the time window is 3-15 seconds and the reporting period is 10-300 seconds.
